(19) United States
(12) Patent Application Publication
(10) Pub. No.: US 2005/0210742 A1
(43) Pub. Date: Sep. 29, 2005

(54) Delivery system and composition

(75) Inventors: Stephen John Carr, Salter Point (AU); Angelo Loi, Carine (AU); William Scott, Watheroo (AU)

Correspondence Address: ROTHWELL, FIGG, ERNST & MANBECK, P.C., 1425 K STREET, N.W., SUITE 800, WASHINGTON, DC, 20005, US

(73) Assignee: Bayclassic Pty Ltd., Yallingup (AU)

(21) Appl. No.: 11/028,504

(22) Filed: Jan. 4, 2005

Related U.S. Application Data
(63) Continuation-in-part of application No. PCT/AU03/00868, filed on Jul. 4, 2003.

(30) Foreign Application Priority Data
Jul. 4, 2002 (AU) PS3383

(51) Int. Cl. A01C 1/06

(52) U.S. Cl. 47/57.6

(57) ABSTRACT

The present invention relates to a delivery system for the administration of microorganisms, the delivery system including at least one species of micro-organisms, water and an aluminosilicate clay and a method for its preparation and use. The delivery system of the present invention is in part intended to provide an inoculant composition for the inoculant of legumes to stimulate root nodule formation and allow improved capacity for storage prior to use.

### CROSS-REFERENCE TO RELATED APPLICATIONS

This application is a continuation-in-part of International Application Serial No. PCT/AU03/00868, filed Jul. 4, 2003.

### FIELD OF THE INVENTION

The present invention relates to a delivery system and composition. More particularly, the delivery system and composition of the present invention are intended for use in the delivery or administration of micro-organisms, including but not limited to, the improved delivery of plant growth promoting rhizobacteria to plants, the inoculation of legumes with root nodule bacteria (e.g. Rhizobium, Bradyrhizobium, Mesorhizobium etc) to stimulate root nodule formation and to allow improved capacity for storage prior to use.

### DESCRIPTION OF THE BACKGROUND ART

There is active research throughout the world aiming to develop growth-promoting or disease protection from micro-organisms applied to agricultural crops. The focus of much of this research is to decrease reliance on chemical application e.g. fertilisers and particularly those that supply nitrogen and phosphorous, and other chemicals associated with disease protection (e.g. fungicides).

The range of growth-promoting micro-organisms known to exert beneficial effects on crop plants are often collectively referred to as Plant Growth Promoting Rhizobacteria (“PGPR”). The term Rhizobacteria refers to micro-organisms inhabiting the rhizosphere, a layer of soil surrounding plant roots that typically has a high level of microbial activity.

PGPR may enhance plant growth by both direct and indirect means, many of which are not well understood. Examples of direct means include synthesis of phytohormones that stimulate root development, fixation of atmospheric nitrogen, solubilization of phosphate and the enhancing of nutrient uptake. The fixation of atmospheric nitrogen is achieved by a range of soil bacteria, including nitrogen fixing root module bacteria (Rhizobium and Bradyrhizobium, there are now other genera described, e.g. Mesorhizobium, Sinorhizobium, Methylobacterium etc.), free living nitrogen-fixing bacteria (e.g. Azotobacter and Azosprillum) and endophytic nitrogen-fixing bacteria (Gluconobacter diazotrophicus), collectively referred to as Biological Nitrogen Fixers (“BNFs”).

Indirect means of plant growth enhancement may include the suppression of the growth of plant pathogens by way of production of antibiotics, siderophores, extracellular enzymes, or by way of the induction of systemic resistance. These means have also been referred to as biologic control. Strains of bacteria identified as potential biocontrol agents include species of Bacillus, Pseudomonas, Burkholderia, Eterobacter and Serratia.

As an example, it is common practice to inoculate leguminous plants with bacterial cultures of the genus rhizobia so that the bacteria will form colonies in nodules within the roots of the legume and fix nitrogen. Rhizobial strains are generally mixed with a carrier to ensure long term storage (but conventional methods have meant long term storage is best achieved under refrigeration) and ease of handling. A large range of substances have been used as carriers including soils, peat, charcoal and lignite.

The known techniques of inoculation include mixing a moist culture of bacteria with a pulverulent carrier. The carrier maintains the bacteria in a moist state whilst giving the total mass the powdery character desired for mixing with seeds.

For rhizobia, embedding cells in a carrier of sterile peat was developed in the 1950s. This methodology remains as commercial best practice today. Nevertheless, it is limited to the application of peat-carrier onto seed. Ideally, seed should be sown into moist soil soon after inoculation. Even under optimal conditions, the death rate of cells on seed can be as high as 90% per day, primarily because of desiccation.

Desiccation is the main factor impacting on rhizobial survival. There is variation in tolerance to different levels of humidity between strains of rhizobia. The rate cells are dried plays an important role in survival, with better survival after slow drying. Slow rehydration also results in better survival. The greater susceptibility of fast-growing rhizobia to desiccation than slow-growing strains has been attributed to their greater retention of water.

Under ideal conditions, the use of peat-based carriers for delivery of rhizobial bacteria to legumes has been relatively effective. Most of Australia's agricultural legumes have been inoculated in this manner for the last 50 years, with varying success. However, there have been biological and economic pressures upon farming in the last decade and these factors have necessitated changes in farming practice. A good example of the biological pressures is best exemplified by the build-up of plant pathogens. For the major Australian pulse crops lupin, chickpea, fababean and field pea, disease pressure is such that all crops are recommended to be sown with seed-applied fungicides. This presents a management conundrum, as fungicides are detrimental to the survival of rhizobia when the two are in close contact or mixed together.

The economic pressures upon farmers have dictated that yields must be maximised, as yield is the greatest determinant of profitability. In dryland cropping, a means to achieve this is through sowing the crop prior to winter rains to maximise water-use efficiency. Weeds are controlled post-sowing, however the rapid death of rhizobia on seed sown into dry soil precludes the dry-sowing option for many crops and pastures. Inoculants on seeds generally also suffer a high mortality rate under this regime. Further complications occur in seasons when early winter rains encourage the sowing of crops, but are not followed by sufficient rains to keep the soil moist. Strategies to regulate water and oxygen gain or loss from rhizobia coated onto seed and how to separate inoculants from toxic chemicals, has posed a challenging research problem.

Current inoculation technology is sub-optimal and legume performance often suffers due to poor nodulation, especially following extended periods of dry, warm weather before adequate rainfall is received. The composition of the current invention is at least in part intended to alleviate this limitation and enable a far more effective rhizobial inoculation.

There is a need for a more favourable and long term storage option for all PGPR, including rhizobial cells. A key attribute of the delivery system and composition of the present invention is its suitability for farming in Mediterranean climates (wet winter, dry summer). In the case of pasture improvement by sowing legumes, farmers have a strong desire to dry sow (i.e. before the winter rainfall commences). On many large farms this is purely a logistical decision due to time restrictions once winter rainfall commences, although there are also economic advantages (e.g. pastures commence growing as soon as rain falls, thus greater yield).

The problems associated with the inoculation of leguminous plants with rhizobia, detailed above, are clearly applicable to the broader group of PGPRs, particularly with regard to the need to allow long term storage and/or early application to crops, whilst maintaining viability of the micro-organisms being so applied.

Similarly, there are further applications in which it is desirable to deliver micro-organisms in a form or manner that maintains viability during and subsequent to administration, but also allows viable storage prior to administration. Such further applications may include mining or mineral processing applications, and also both medical and veterinary applications. For example, the bacterial leaching of ores and concentrates, in any of tanks, vats, heaps or dumps may benefit from an efficient delivery system of viable micro-organisms.

The present invention has as one object thereof to overcome substantially, or at least provide a useful alternative to, the above-mentioned problems associated with the prior art.

The preceding discussion of the background to the invention is intended to facilitate an understanding of the present invention. However, it should be appreciated that the discussion is not an acknowledgement that any material referred to was part of the common general knowledge in Australia as at the priority date of the application.

Throughout the specification, unless the context requires otherwise, the word “comprise” or variations such as “comprises” or “comprising”, will be understood to imply the inclusion of a stated integer or group of integers but not the exclusion of any other integer or group of integers.

### SUMMARY OF THE INVENTION

In accordance with the present invention there is provided a delivery system for the administration of micro-organisms, the delivery system comprising at least one species of micro-organism, water and an aluminosilicate clay, wherein the aluminosilicate clay comprises at least one of calcium bentonite and saponite.

Preferably, the delivery system further comprises a food source that also provides a protective envelope for the micro-organisms. The food source preferably comprises organic acids in the form of peat.

In one form of the invention the or each micro-organism is chosen for a beneficial effect it may exert, directly or indirectly, for the purpose of one or more of plant growth promotion, mineral processing, medical or veterinary applications.

In an advantageous form of the present invention the micro-organisms comprise at least in part one or more PGPR and even more advantageously, the micro-organisms comprise at least in part one or more rhizobial bacteria.

In accordance with the present invention there is further provided a inoculant composition comprising at least one species of micro-organism, water and an aluminosilicate clay, wherein the aluminosilicate clay comprises at least one of calcium bentonite and saponite.

Preferably, the composition comprises said aluminosilicate clay to which said micro-organisms and water have been added. The composition may further advantageously comprise peat.

The peat and the micro-organisms may be provided in the form of a peat-based inoculant. The peat is preferably provided in a proportion of between about 0.1 to 50% by weight of the inoculant composition.

It should be understood that the ratio of peat may vary with the type of microbial strains utilised. For some strains the ratio of peat to clay may be 1:10, some it will be 1:20 and some it will be 1:40.

The clay preferably comprises aggregate particle sizes ranging between about 0.2 and 10 mm in diameter. Still preferably, the clay comprises aggregate particle sizes ranging between about 0.5 and 2 mm in diameter.

The clay is preferably provided in a proportion of between about 50 to 99.9% by weight of the composition. Further preferably, the clay is provided in a proportion of between about 75 to 99.9% by weight of the composition.

Preferably, the micro-organism is specific to a plant to be inoculated.

Preferably, the composition is provided in the form of granules. The size of the granules are preferably either similar to or smaller than the plant seeds to be inoculated. The granules are still preferably between about 0.1 to 5 mm in diameter. The granules are yet still preferably between about 0.1 to 2 mm in diameter.

In one form of the invention the composition is provided in the form of a mixture comprising:
a first portion of granules sized approximately the same size as plant seeds to be inoculated; and
a second portion of particulate matter more finely divided than the granules of the first portion.

The first portion of granules are preferably between about 0.1 to 5 mm in diameter. The second portion of particulate matter preferably has a size of less than about 0.1 mm.

Preferably, the inoculant comprises between about 2 and 20% water. Still preferably, the inoculant comprises between about 5 and 15% water. Still further preferably, the inoculant comprises between about 6 and 9% water. During storage of the inoculant composition, the water concentration may decrease depending on storage conditions and humidity.

In an advantageous form of the present invention the micro-organisms comprise at least in part one or more PGPR and even more advantageously, the micro-organisms comprise at least in part one or more rhizobial bacteria.

It should be understood that the ratio of peat may vary with the type of rhizobial strain utilised. For some strains the ratio of peat to clay may be 1:10, some it will be 1:20 and some it will be 1:40.

The legume may be any crop, pasture, tree or fodder legume used in an agricultural situation or tropical legumes and may be selected from the group comprising clover, lupins, serradella, biserrula, medics, chickpea, fababean, lentil, beans, peanuts, field pea, burgundy bean, any bean, French or common bean, Vigna spp, Centrosema spp, Desmodium spp, Desmanthus spp, Stylosanthes spp, Leucana spp and the like. The inoculant of the present invention has substantial application with respect to tropical legumes, where high temperatures and more rapid desiccation impacts even more severely on rhizobial survival compared with the Mediterranean style winter sown legumes.

For pasture legumes, the size of the granules of the rhizobial inoculant may be either similar or smaller than the legume seeds, ranging between about 0.1 and 5 mm, but most preferably between about 0.1 and 2 mm. In the case of crop and pulse legumes, the rhizobial inoculant granules are preferably between about 0.1 and 5 mm (most preferably between about 0.1 and 2 mm) which is preferably smaller than the legume seeds.

In providing granules of similar but smaller size to the seed to be inoculated, mixing and uniformity of ‘flow’ through seeding machinery is facilitated leading to enhanced distribution of seed and granules in the sown crop or pasture. Further, the very fine granules are able to adhere to the surface of the legume seed being sown, thus providing greater proximity between the seed and the inoculant source leading to more rapid formation of functional nodules when the plant germinates and commences growing.

The ratios of the first portion of granules and the second portion of granules is dependant on factors such as seed type, water content of the inoculant and sowing rates. Smaller granules are better adapted to adhere to seed surfaces and provide better distribution in sown rows, although higher proportion of finer granules, whilst potentially leading to more rapid rates of nodulation, create greater handling problems when sowing. The larger granules more easily facilitate movement through agricultural machinery.

It is preferable for the inoculant to contain an amount of water sufficient to maintain the rhizobial cells in a viable state. If the water content is too high, logistical problems are encountered in the sowing of the granules with legume seeds.

The inoculant composition of the present invention may further comprise a fungicide, fungal spores or additional growth promoting bacteria.

In accordance with the present invention there is further provided a method for the preparation of a delivery system, the method characterised by the method steps of:
a) blending the components micro-organisms, water and an aluminosilicate clay comprising at least one of calcium bentonite and saponite to form a slurry; and
b) drying the slurry.

The method preferably further includes the step of:
a) blending peat with the slurry.

In accordance with the present invention there is yet still further provided a method for the preparation of a delivery system, the method characterised by the method steps of:
a) blending the components peat, micro-organisms and water to form a slurry;
b) incubating the slurry to increase bacteria numbers;
c) adding an aluminosilicate clay comprising at least one of calcium bentonite and saponite to the slurry; and
d) drying the slurry.

The incubation step preferably further includes the steps of:
i) adding a carbon source; and
ii) agitating the slurry in a sterile environment.

The carbon source is preferably provided in the form of sucrose, glucose, brewery waste and the like. Preferably, the carbon source is added at a concentration of between about 1 to 5% by weight.

The slurry is preferably agitated for between about 48 and 96 hours.

In accordance with the present invention there is further provided a method for the preparation of a delivery system, the method characterised by the method steps of:
a) incubating a culture of at least one micro-organism in water to increase numbers thereof;
b) adding an aluminosilicate clay comprising at least one of calcium bentonite and saponite to the culture to form a slurry; and
c) drying the slurry.

Preferably, the culture is incubated for between about 24 and 72 hours.

The method preferably further comprises the additional step of:
agitating the culture of step a).

Preferably, the culture is agitated for between about 24 to 48 hours.

The method preferably further includes the step of:
adding peat to the culture of step a).

The peat and micro-organisms are preferably provided in the form of a peat-based inoculant. The peat-based inoculant is preferably stored in a fridge prior to use and is warmed to room temperature prior to blending.

Preferably, water comprises between about 10 to 90% of the total mass of peat and aluminosilicate clay in the slurry. The water still preferably comprises between about 30 to 80% of the total mass of peat and aluminosilicate clay in the slurry. The water yet still preferably comprises between about 55 to 75% of the total mass of peat and aluminosilicate clay in the slurry.

The method preferably further includes the step of:
allowing the slurry to stand prior to drying.

The slurry may be air dried, oven dried or vacuum dried. Preferably, the slurry is air dried in a batch or continuous process. The air drying may preferably performed at about 20° C. for between about 24 and 120 hours.

The depth of slurry in the batch is preferably maintained between about 2 cm to 4 cm. The depth of slurry in the batch is still preferably maintained between about 2 cm to 3 cm.

The method may further include the step of:
milling the composition to provide granules.

In an advantageous form of the present invention the micro-organisms comprise at least in part one or more PGPR and even more advantageously, the micro-organisms comprise at least in part one or more rhizobial bacteria.

In accordance with the present invention there is provided a method of inoculation of legumes, the method characterised by the method steps of:
a) mixing granules of rhizobial inoculant as described above with legume seeds or with fertiliser sown with legumes seeds; and
b) sowing the mixture.

The mixture may preferably be sown prior to winter rains.

Preferably, the legume seed is sown at rates between about 1 and 150 kg/ha, with most preferably, the rate of granular inoculants between about 5 and 20 kg/ha.

The method may further include the step of:
adding fertiliser to the mixture.

In one form of the invention, the method further includes the step of:
applying a fungicide to a legume seed prior to mixing the seed with the granules.

### BRIEF DESCRIPTION OF THE DRAWINGS

The present invention will now be described, by way of example only, with reference to three embodiments thereof and the accompanying Figures, in which:—

FIG. 1 is a plot showing nodule score of vicia faba plants inoculated with inoculant composition in accordance with a first embodiment of the present invention, inoculated with conventional peat based inoculant and vicia faba plants without inoculation;

FIG. 2 is a plot showing nodule score of lentils inoculated with inoculant composition in accordance with the first embodiment, inoculated with conventional peat based inoculant and lentils without inoculation;

FIG. 3 is a plot showing nodule score of lentils inoculated with inoculant composition in accordance with the first embodiment, inoculated with conventional peat based inoculant and lentils without inoculation;

FIG. 4 is a plot showing nodule score of lentils inoculated with inoculant composition in accordance with the first embodiment, lentils inoculated with granules in accordance with the first embodiment and stored in an environment of varying temperatures, inoculated with conventional peat based inoculant and lentils without inoculation; and

FIG. 5 is a plot showing the results of field tests on the inoculation of field peas with (Pisum sativum) inoculated with inoculant composition in accordance with a second embodiment of the present invention, field peas inoculated with commercially available peat based inoculants, field peas inoculated with clay and uninoculated field peas.

### DETAILED DESCRIPTION OF THE INVENTION

Three embodiments of the present invention will now be described with reference to a delivery system and composition for rhizobial inoculation. It is to be understood that these embodiments are detailed by way of example and are not to be considered limiting.

In a first embodiment of the present invention, water (67% of total mass of clay), at 20° C. was added to a strain of commercially available peat-based inoculant (0.1 to 50% by weight of the rhizobial inoculant composition. For trials, ratios of 1:10, 1:20 and 1:40 of peat based inoculant to clay were used. See specific examples for ratios used.). The peat based inoculant had been stored in a fridge and was allowed to warm to room temperature before use. The composition was stirred thoroughly and was left to stand for 15 min at 20° C.

A calcium bentonite or saponite clay (90% by weight of the rhizobial inoculant composition for the 1:10 composition described above) that had been milled to aggregate particle size of less than about 2 mm was added and the slurry stirred for 15 min. The clay had been air dried to a water content of about 6 to 10% by weight.

The slurry was air dried at 20° C. for between 24 hr and 120 hr depending on the batch size. Once the composition was dried sufficiently, it was crushed and milled The moisture content of the composition prior to crushing and milling was about 10%.

In a second embodiment of the present invention, water (67% of total mass of clay), at 20° C. was added to a strain of commercially available peat based inoculant (0.1 to 50% by weight of the rhizobial inoculant composition. For trials, ratios of 1:10, 1:20 and 1:40 of peat based inoculant to clay were used. See specific examples for ratios used.). The peat based inoculant had been stored in a fridge and was allowed to warm to room temperature before use. The composition was stirred thoroughly and was left to stand for 15 min at 20° C.

A carbon source in the form of sucrose, glucose or brewery waste was added at a concentration of between about 0.5 to 5% by weight and the mixture agitated under sterile conditions for between 48 and 96 hours.

A calcium bentonite or saponite clay (90% by weight of the rhizobial inoculant composition for the 1:10 composition described above) that had been milled to aggregate particle size of less than about 2 mm was added and the slurry stirred for 15 min. The clay had been air dried to a water content of about 6 to 10% by weight.

The slurry was air dried at 20° C. for between 24 hr and 120 hr depending on the batch size. Once the composition was dried sufficiently, it was crushed and milled. The moisture content of the composition prior to crushing and milling was about 10%.

In a third embodiment of the present invention, a culture of rhizobial bacteria was fermented in water (or other typical nutrient broths for growing bacteria) with sucrose or other food source for between about 24 to 72 hours to increase cell numbers, after which time sterile peat was added and the culture agitated for between about 24 to 48 hours. Clay was then added to the mixture in the manner described above.

Test results show equivalent cells per g dry bentonite can be achieved (Table 1).

TABLE 1
Bacteria cell numbers of commercial peat and
culture prepared by the method of the invention.

| | | | | |
|---|---|---|---|---|
| Manufacture system | 0 hrs | 72 hrs | 120 hrs | 168 hrs |
| Culture added to sterile | 2.95E+08 | 2.81E+08 | 4.02E+07 | 2.66E+07 |
| peat | | | | |
| Commercial Peat | 9.30E+07 | 1.86E+07 | 1.17E+07 | 1.19E+07 |

The three embodiments described above are three methods that produce an inoculant suitable for the inoculation of legumes. The bacteria are selected based on the intended species of legume to be inoculated. The following examples utilise inoculants produced according to the first embodiment utilising rhizobial bacteria specific to the legume being sown. Granules of the composition of the first embodiment were mixed with legume seeds and the mixture sown. It is believed that when the plants grow, their roots intercept inoculant granules that are in close proximity to the emerging seedling and the rhizobial cells they contain enable the nodulation process. In the absence of other limiting factors (e.g. nutrition and water supply) the effectiveness of nodulation in legumes can be assessed by dry matter production (i.e. larger plants have better nodulation). Visual observations of the roots of the plant reported in Tables 2, 3 and 4 confirm this with more widespread nodulation and greater nodule numbers than ‘conventionally’ inoculated legumes.

### EXAMPLE 1

Dry matter of 9 weeks old plants of Biserrula (Biserrula pelecinus) inoculated with granules of inoculant of the present invention manufactured using ratios of peat to clay (1:1, 1:10 and 1:100) was equivalent or better than conventionally inoculated biserrula as seen in Table 2. There is no chance of contamination affecting the trials as the rhizobial strain for Biserrula pelecinus is unique. (i.e. no other legumes can use this strain of bacteria and no other natural strain can be used by Biserrula. Biserrula is a monotypic genus (single species)).

TABLE 2
Dry matter yield (g) of biserrula (cv Casbah) grown for 9 weeks.
Dry matter yield (g/pot) of Casbah inoculated with clay based granules
different ratios of clay:peat, compared with conventional inoculation.

| | | | | Conventional |
|---|---|---|---|---|
| | 1:1 granule | 1:10 granule | 1:100 granule | inoculation |
| | g | g | g | g |
| Rep 1 | 0.698 | 0.473 | 0.539 | 0.456 |
| Rep 2 | 0.807 | 0.811 | 0.655 | 0.518 |
| Rep 3 | 0.556 | 0.630 | 0.645 | 0.584 |
| Rep 4 | 0.710 | 0.685 | 0.559 | 0.473 |
| Mean | 0.693 | 0.650 | 0.600 | 0.508 |
| Std err | 0.052 | 0.070 | 0.030 | 0.029 |

Inoculant source for both granule production and conventional inoculation was WSM 1497, biserrula special. Uninoculated controls were used in the experiment to provide extremes of plant performance for comparison (data are not reported because the plants died 3 weeks after sowing from lack of nitrogen supply).

### EXAMPLE 2

Storage of manufactured granules at temperatures fluctuating between 60° C. (day) and 15° C. (night) for 2 weeks (simulation of an average summer day) did not impact on dry matter yield of biserrula (cv Casbah) inoculated with granules of rhizobial inoculant as seen in Table 3. Trials did not include peat treated under similar conditions as it is known that the rhizobium is not able to survive at temperatures over 5° C. under these conditions.

TABLE 3
Impact of high temperature fluctuation (60/15° C.) on granules stored
for 2 weeks prior to sowing biserrula (cv Casbah) grown for 7 weeks.
Dry matter yield (g) of biserrula (cv Casbah) grown for 7 weeks.

| | | | | Conventional |
|---|---|---|---|---|
| | | | | inoculation prior |
| | 1:1 granule | 1:10 granule | 1:100 granule | to sowing |
| | g | g | g | g |
| Rep 1 | 0.075 | 0.103 | 0.079 | 0.101 |
| Rep 2 | 0.054 | 0.110 | 0.075 | 0.100 |
| Rep 3 | 0.053 | 0.072 | 0.070 | 0.095 |
| Rep 4 | 0.068 | 0.079 | 0.028 | 0.097 |
| Mean | 0.063 | 0.091 | 0.063 | 0.098 |
| Std err | 0.005 | 0.009 | 0.012 | 0.001 |

### EXAMPLE 3

Granules manufactured with different ratios of water were able to cope with extreme temperatures fluctuating between 60° C. (day) and 15° C. (night) for 4 weeks as seen in Table 4. Storage for 4 weeks under this harsh regime did not impact on dry matter yield of Casbah biserrula inoculated with granules subjected to these conditions.

Without being limited by theory, it is proposed that the cell numbers surviving in the inoculant granules at the time of nodulation are greater than pure peat (the commercial carrier) on the surface of conventionally inoculated legumes. The organic acids in the peat supply a food source and enable multiplication and subsequent survival. This does not happen in peat alone (due to lack of sufficient moisture and space).

TABLE 4
Impact of high temperature fluctuation (60/15° C.) on
granules produced using variable water contents and stored for
4 weeks prior to sowing biserrula (cv Casbah) grown for 4 weeks.
Dry matter yield (g) of biserrula (cv Casbah) grown for 4 weeks.

| | | | | Conventional |
|---|---|---|---|---|
| | 1:1 granule | 1:1 granule | 1:1 granule | inoculation prior |
| | 33% water | 50% water | 66% water | to sowing |
| | g | g | g | g |
| Rep 1 | 0.014 | 0.031 | 0.019 | 0.020 |
| Rep 2 | 0.017 | 0.024 | 0.021 | 0.022 |
| Rep 3 | 0.019 | 0.026 | 0.022 | 0.024 |
| Rep 4 | 0.013 | 0.020 | 0.018 | 0.021 |
| Mean | 0.016 | 0.025 | 0.020 | 0.022 |
| Std err | 0.001 | 0.002 | 0.001 | 0.001 |

### EXAMPLE 4

In a glasshouse experiment, dry matter production of Casbah biserrula plants inoculated with rhizobial inoculant stored at different temperature regimes for 8 weeks (constant 20° C. compared with a fluctuating 60° C./15° C., equivalent to a hot summers day and night) was equivalent to fresh peat inoculation as seen in Table 5.

TABLE 5
Dry matter production of Casbah biserrula grown for four weeks,
and inoculated with granules produced and stored under different
temperature regimes for 8 weeks prior to sowing biserrula.

| Treatment | Mean | St err |
|---|---|---|
| Nil | 0.014 | 0.005 |
| Fresh Peat | 0.061 | 0.014 |
| 60° C./15° C. composition 8 weeks | 0.076 | 0.024 |
| 60° C./15° C. composition 8 weeks PD | 0.098 | 0.044 |
| 20° C. composition 8 weeks | 0.052 | 0.008 |

Plants inoculated with granules subjected to the most severe temperature regime and positionally disadvantaged (i.e. seed and granule separated in pot) were still able to nodulate and produce equivalent biomass (Table 5).

PD is an acronym for positionally disadvantaged, which in the context of the specification, is intended to mean a process of sowing seeds and granules of the inoculant composition in a pot whereby the seeds and granules are placed as far apart as possible.

### EXAMPLE 5

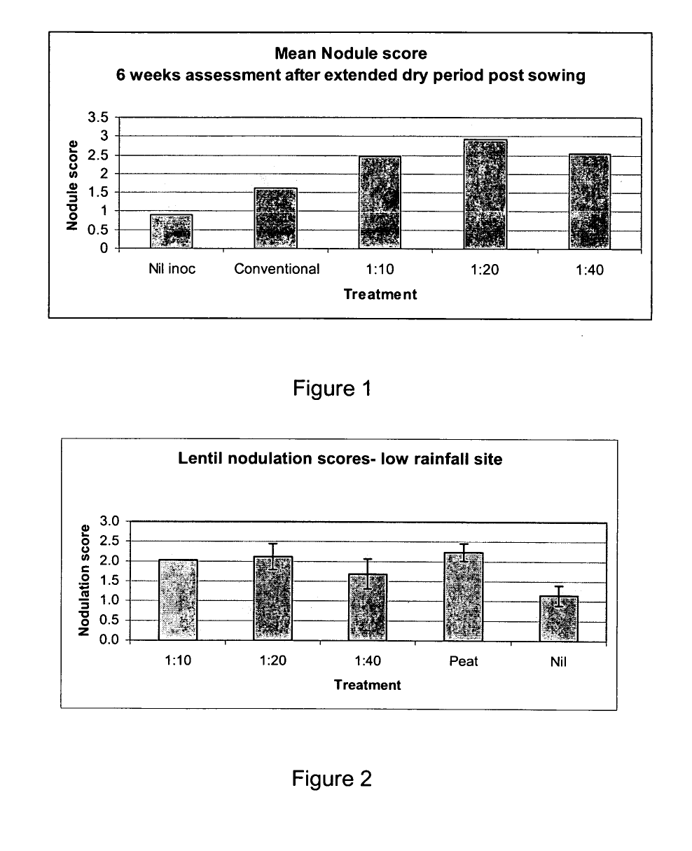

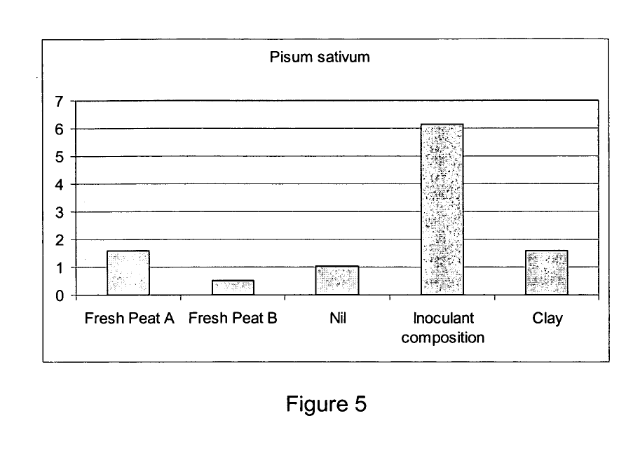

The results of field experiments shown in FIGS. 1 to 4 used inoculant compositions prepared by the first embodiment. The results shown in FIG. 5 used inoculant composition prepared by the second embodiment. All trials used sowing rates of inoculant composition of 10 kg/ha.

In a field experiment sown to compare nodulation of Vicia faba either conventionally inoculated (with peat based inoculant) or with rhizobial inoculant of the present invention, there were considerable differences noted in early (6 weeks) nodulation scores, as shown in FIG. 1. (1:10, 1:20 and 1:40 refer to compositions of the present invention with varying ratios of peat based inoculant to clay). Following sowing, there was an extended dry period, and the conventionally inoculated plants nodulated poorly under this regime. The plants inoculated with granules, were able to source adequate rhizobia from the granules when rainfall did return.

In a low rainfall environment, lentils inoculated with granules had equivalent nodulation scores to standard peat inoculated plants, and these were all superior to nil inoculation, as can be seen in FIG. 2.

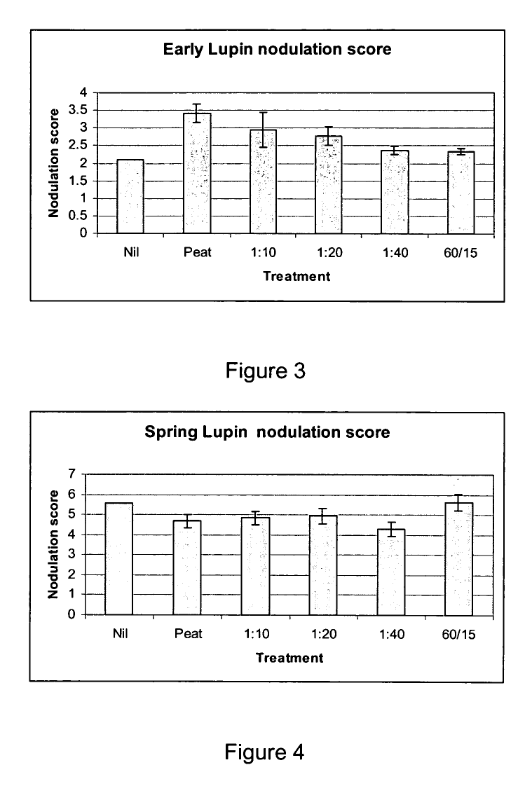

Effective legume growth is reliant on early nodulation and nitrogen fixation. Some plants (e.g. lupins that have evolved on sandy soils), are still capable of nodulating later in the season when they have exploited soil nitrogen. Early nodulation of lupins conventionally inoculated were slightly better than plants inoculated with granules, as shown in FIG. 3. However, by spring these differences had disappeared, shown in FIG. 4. It should be noted, differences in biological and grain yield in lupins are not necessarily correlated with nodulation scores.

In a field experiment to compare nodulation of Vicia faba, either conventionally inoculated (with peat based inoculant) or with rhizobial inoculant composition of the present invention, there were considerable differences noted in early (6 weeks) nodulation scores, as shown in FIG. 1 (1:10, 1:20 and 1:40 refer to compositions of the present invention with varying ratios of peat based inoculant to clay). Following sowing, there was an extended dry period and the conventionally inoculated plants nodulated poorly under this regime. The plants inoculated with the composition of the present invention were able to source adequate rhizobia from the composition when rainfall did return.

It will be appreciated that different species of crop and pasture legumes may be inoculated with different rhizobial strains.

The composition and delivery system of the current invention has been developed to provide a more favourable environment for survival of micro-organisms, for example the rhizobia described above, and permits rhizobial respiration to proceed during desiccation, leading to enhanced survival of inoculants and ultimately greater impact on plant growth. This is thought to be due to the lattice structure of the clay allowing impregnation with actively growing rhizobial cells. This obviates the requirement that legume seeds be inoculated immediately prior to planting.

A further advantage of the present invention is that it aids disease suppression in legume crops. Many crop legumes exhibit a high degree of susceptibility to a range of foliar diseases. With conventionally inoculated legumes (i.e. peat added to the seed surface), fungicides can not be applied directly to seed as the fungicides kill rhizobial cells as well as fungal spores. The present invention aims to alleviate this problem and provide a delivery system and method of inoculation wherein fungicide may be applied to seeds without adversely affecting the rhizobial bacteria which are supplied separately in the clay based granules.

It is envisaged that the delivery system and composition described hereinabove in respect of the inoculation of legumes with rhizobial bacteria is readily adaptable for broader application in respect of PGPRs and their application to a wide variety of plants, not necessarily limited to agriculture crops.

It is still further envisaged that the delivery system and composition of the present invention will prove beneficial in the delivery of micro-organisms in additional fields requiring viability to be maintained prior and/or subsequent to delivery/application. One such field is mineral processing and the delivery of bacteria to biological leaching systems, including heap leaches, which typically utilise bacterial strains capable of oxidising the ores and/or concentrates used to form them, in an effort to subsequent liberate valuable metal species therefrom. Typically, a solution containing the bacterial species is applied to the top of the heap and is allowed to percolate therethrough, the pregnant leach solution being collected at the base of the heap and either recycled to the heap or being bled to a metals recover circuit. Bacterial species administered in this manner have included Thiobacillus ferrooxidans, Thiobacillus thiooxidans and Leptospirillum ferrooxidans, in the biooxidation of arsenopyrite, pyrite, pyrrhotite, covellite and chalcopyrite ores, for example. The delivery system and composition of the present invention has application in the delivery of viable bacteria of the appropriate species to biooxidative leach systems, whether they be heaps, dumps, vats or tanks.

It is yet still further envisaged that the delivery system and composition of the present invention will have application in the delivery of viable micro-organisms in medical and veterinary applications, whether that be by way of oral or rectal administration. The benefits with regard to shelf life remain the same, as does the ability to deliver viable microbes to a target, which may be a certain portion of the gut.

While advantageous and preferred embodiments of the present invention have been selected as an illustration of the invention, it should be understood by those skilled in the art that changes and adaptations can be made therein without departing from the scope of the invention.

1. A delivery system for the administration of micro-organisms, the delivery system comprising at least one species of micro-organism, water and an alumino-silicate clay, wherein the aluminosilicate clay comprising at least one of calcium bentonite and saponite.

2. A delivery system according to claim 1, wherein the delivery system further comprises a food source for the micro-organisms.

3. A delivery system according to claim 2, wherein the food source comprises peat.

4. A delivery system according to claim 1, wherein the micro-organism is a rhizobial bacteria.

5. An inoculant composition comprising at least one species of micro-organism, water and an aluminosilicate clay, wherein the aluminosilicate clay comprises at least one of calcium bentonite and saponite.

6. An inoculant composition according to claim 5 further comprising peat.

7. An inoculant composition according to claim 5, wherein the composition is provided in the form of granules.

8. An inoculant composition according to claim 7, wherein the size of the granules are either similar to or smaller than the plant seeds to be inoculated.

9. An inoculant composition according to claim 7, wherein the granules are between about 0.1 to 5 mm in diameter.

10. An inoculant composition according to claim 7, wherein the granules are between about 0.1 to 2 mm in diameter.

11. An inoculant composition according to claim 5, wherein the composition is provided in the form of a mixture comprising:
a first portion of granules sized approximately the same size as plant seeds to be inoculated; and
a second portion of particulate matter more finely divided than the granules of the first portion.

12. An inoculant composition according to claim 11, wherein the first portion of granules are between about 0.1 to 5 mm in diameter.

13. An inoculant composition according to claim 12, wherein the second portion of particulate matter has a size of less than about 0.1 mm.

14. An inoculant composition according to claim 5, wherein the inoculant comprises between about 2 and 20% water.

15. An inoculant composition according to claim 5, wherein the inoculant comprises between about 5 and 15% water.

16. An inoculant composition according to claim 5, wherein the inoculant comprises between about 6 and 9% water.

17. An inoculant composition according to claim 5, wherein the micro-organism is a rhizobial bacteria.

18. An inoculant composition according to claim 5, wherein the inoculant composition further comprises a fungicide, fungal spores or additional growth promoting bacteria.

19. A method for the preparation of a delivery system, the method characterised by the method steps of:
a) blending the components micro-organisms, water and an aluminosilicate clay to form a slurry; and
b) drying the slurry.

20. A method for the preparation of a delivery system according to claim 19, wherein the method further includes the step of:
c) blending peat with the slurry.

21. A method for the preparation of a delivery system, the method characterised by the method steps of:
a) blending the components peat, micro-organisms and water to form a slurry;
b) incubating the slurry to increase bacteria numbers;
c) adding clay to the slurry; and
d) drying the slurry.

22. A method for the preparation of a delivery system according to claim 21, wherein the incubation step further includes the steps of:
i) adding a carbon source; and
ii) agitating the slurry in a sterile environment.

23. A method for the preparation of a delivery system according to claim 22, wherein the carbon source is provided in the form of sucrose, glucose, brewery waste and the like.

24. A method for the preparation of a delivery system according to claim 22, wherein the carbon source is added at a concentration of between about 1 to 5% by weight.

25. A method for the preparation of a delivery system according claim 22, wherein the slurry is agitated for between about 48 and 96 hours.

26. A method for the preparation of a delivery system, the method characterised by the method steps of:
a) incubating a culture of at least one micro-organism in water to increase numbers thereof;
b) adding clay to the culture to form a slurry; and
c) drying the slurry.

27. A method for the preparation of a delivery system according to claim 26, wherein the culture is incubated for between about 24 and 72 hours.

28. A method for the preparation of a delivery system according to claim 26, wherein the method comprises the additional step of:
agitating the culture of step a).

29. A method for the preparation of a delivery system according to claim 28, wherein the culture is agitated for between about 24 to 48 hours.

30. A method for the preparation of a delivery system according to claim 26, wherein the method further includes the step of:
adding peat to the culture of step a).

31. A method for the preparation of a delivery system according to claim 20, wherein the peat and micro-organisms are provided in the form of a peat based inoculant.

32. A method for the preparation of a delivery system according to claim 20, wherein the peat based inoculant is stored in a fridge prior to use and is warmed to room temperature prior to blending.

33. A method for the preparation of a delivery system according to claim 19, wherein water comprises between about 10 to 90% of the total mass of peat and clay in the slurry.

34. A method for the preparation of a delivery system according to claim 19, wherein water comprises between about 30 to 80% of the total mass of peat and clay in the slurry.

35. A method for the preparation of a delivery system according to claim 19, wherein water comprises between about 55 to 75% of the total mass of peat and clay in the slurry.

36. A method for the preparation of a delivery system according to claim 19, wherein the method further includes the step of:
allowing the slurry to stand prior to drying.

37. A method for the preparation of a delivery system according to claim 19, wherein the slurry is air dried, oven dried or vacuum dried.

38. A method for the preparation of a delivery system according to claim 37, wherein the slurry is air dried in a batch or continuous process.

39. A method for the preparation of a delivery system according to claim 38, wherein the air drying is performed at about 20° C. for between about 24 and 120 hours.

40. A method for the preparation of a delivery system according to claim 38, wherein the depth of slurry in the batch is maintained between about 2 cm to 4 cm.

41. A method for the preparation of a delivery system according to claim 38, wherein the depth of slurry in the batch is maintained between about 2 cm to 3 cm.

42. A method for the preparation of a delivery system according to claim 19, wherein the method further includes the step of:
milling the composition to provide granules.

43. A method for the preparation of a delivery system according to claim 19, wherein the micro-organisms comprise at least in part one or more PGPR.

44. A method for the inoculation of legumes, the method characterised by the method steps of:
a) mixing granules of an inoculant composition according to claim 5 containing rhizobial bacteria with legume seeds; and
b) sowing the mixture.

45. A method for the inoculation of legumes according to claim 44, wherein the method further includes the step of:
sowing the mixture prior to winter rains.

46. A method for the inoculation of legumes according to claim 44, wherein the legume seed is sown at rates between about 1 and 150 kg/ha.

47. A method for the inoculation of legumes according to claim 44, wherein the legume seed is sown at rates between about 5 and 20 kg/ha.

48. A method for the inoculation of legumes according to claim 44, wherein the method further includes the step of:
applying a fungicide to a legume seed prior to mixing the seed with the rhizobial inoculant.

49. A method for the inoculation of legumes according to claim 44, wherein the legume is crop, pasture, tree or fodder legume used in an agricultural situation or tropical legumes and may be selected from the group comprising clover, lupins, serradella, biserrula, medics, chickpea, fababean, lentil, beans, peanuts, field pea, burgundy bean, any bean, French or common bean, Vigna spp, Centrosema spp, Desmodium spp, Desmanthus spp, Stylosanthes spp, Leucana spp and the like.
